(19) United States
(12) Patent Application Publication
(10) Pub. No.: US 2026/0193412 A1
(43) Pub. Date: Jul. 9, 2026

(54) SELECTIVELY ACTIVATED DIAZIRINE-CONTAINING MOLECULES AND POLYMERS

(71) Applicant: XLYNX MATERIALS INC., Sidney (CA)

(72) Inventor: Stefania Francesca MUSOLINO, Victoria (CA)

(73) Assignee: XLYNX MATERIALS INC., Sidney, BC (CA)

(21) Appl. No.: 19/133,035

(22) PCT Filed: Nov. 15, 2023
(86) PCT No.: PCT/CA2023/051535

§ 371 Date: May 27, 2025

Related U.S. Application Data
(60) Provisional application No. 63/429,838, filed on Dec. 2, 2022.

(51) Int. Cl. C08G 73/02; C08G 65/48

(52) U.S. Cl. CPC C08G 73/0206; C08G 65/48

(57) ABSTRACT

A novel family of multi-diazirine-based molecules and polymers with the potential for dual activation, as well as methods of manufacture and uses thereof, are described.

### TECHNICAL FIELD

The disclosure relates generally to polymers and, more particularly, to post-polymerization functionalization, crosslinking, and adhesion of polymers

### INTRODUCTION

Low-functionality commodity polymers (e.g., polyethylene, polypropylene) make up a vast portion of the global plastics supply due to their advantageous chemical properties and low cost. Even though their use is already widespread (from food packaging to ultra-high strength fibers), their range of applications could be dramatically increased by improving their compatibility, paintability, and adhesion to like materials and other common substrates (e.g. metal, glass, wood, coatings). Their poor affinity for oxygen- and nitrogen-based polymers, and polar pigments, limits their uses as adhesives and their compatibility with coatings. The introduction of controlled levels of functionality could help to enhance their properties without negatively influencing the physical characteristic of the parent material. However, saturated hydrocarbons may be poorly reactive unless used under specialized conditions. Conventional functionalization methods include the use of radicals (H-abstraction) or carbenes (C—H insertion).

The introduction of functional groups (e.g., polar groups) on polyolefins to help with adhesion was traditionally done through free-radical mechanisms (e.g. peroxides, photo-oxidation) [Eur. Polym. J. 1983, 19, 863-866]. This approach is unpredictable and may compromise the proprieties of the parent materials (e.g. chain breaking and/or crosslinking). These reactions usually require elevated temperatures and extreme conditions.

One of the most common methods is the use of maleic anhydride-based radicals to introduce an electrophilic functionalization on the polymeric chains. This functionalization is performed in the melt, generally using temperatures above 200° C. However, chain scissions compete with the functionalization of the polymer, particularly for polypropylene. Moreover, for polymers like polyethylene, crosslinking competes with functionalization, generating unwanted branching.

Carbene chemistry is an alternative to free radical functionalization using diazo or nitrene compounds. For example, Aglietto et al. [Polymer, 1989, 30, 1133-1136] used ethyldiazoacetate (diazo compound) to functionalize polyolefins. The reaction proceeded without generating unwanted crosslinking. Alternatively, rhodium-catalyzed examples of functionalization of linear alkanes (small models for polyethylene chains) were described by Demonceau et al. [J. Chem. Soc., Chem. Commun., 1981, 688-689] using diazo esters under mild conditions.

Another class of functionalizing molecules is nitrenes. For example, sulfonyl azides may undergo C—H insertion to polyethylene upon thermal decomposition, generating reactive nitrenes (in a singlet state) [J. Appl. Polym. Sci., 2002, 84, 1395-1402]. One common application is the use of poly(sulfonyl azide) s for the functionalization of polyethylene. This is accomplished by introducing sulfonamide groups as pendants and increasing the compatibility of the polyethylene with Nylon in the resultant blend. The new interactions between the two polymers improve tensile and impact properties.

Diazirines may also be used for polymer functionalization. Upon thermal, photochemical, or electrochemical activation or via energy transfer from an activated photosensitizer species, diazirines generate singlet or triplet carbenes which insert into C—H bonds of aliphatic polymers like polyethylene and polypropylene. WO/2021/179064A1 describes the functionalization of woven melted polypropylene using photosensitizer moieties chemically bonded to at least one diazirine. Strong adhesion of the diazirine to commodity polymers generates a functionalized polymer with antimicrobial proprieties. Wulff et al. [ACS Applied Polymer Materials, 2022, 4, 1728-1742] also described a polyamine-diazirine conjugate for use as a primer in composite materials.

Diazirine-based molecules may also be used as crosslinkers to increase the mechanical strength and thermal stability of polymers and to reduce material creep at elevated temperatures. Methods are known in the art of crosslinking polymers using diazirines. For example, Burgoon (U.S. patent applications 20160083352 and 20180186747) discloses a family of diazirines useful as photo-crosslinkers in the preparation of photo-imageable compositions for film-coating microelectronic or optoelectronic devices. WO/2020/215144 discloses a series of novel diazirines which may be used as polymer adhesives (e.g. crosslinking nonfunctionalized polymers, such as polyolefins). WO/2022/187932 discloses a series of novel diazirines with higher insertion yields, due to increased stabilization of the singlet carbene, and milder activation. Wulff et al. [Chemical Science, 2021, 12, 12138-12148] described fine-tuneability within the chemical structure of the diazirine itself.

Regardless of the above-mentioned methods of post-polymerization or post-functionalization of polyolefins, conventional methods rely on the simplistic functionalization of the polymer with a specific functional group (e.g. additional polar groups to enhance adhesion) [Chem. Soc. Rev., 2005, 34, 267-275]. In the art of post-polymerization functionalization of commodity polymers, the ability to introduce a universal reactive moiety on the polymeric chain, which may further react or crosslink with any other material, is still needed.

It has now been discovered that the new family of compounds disclosed herein has significant advantages over the previous methods of functionalization present in the state-of-art. Specifically, a new generation of crosslinkers with dual activation (selective activation) method of action has been disclosed herein.

### SUMMARY

There is disclosed a novel family of multi-diazirine-based molecules and polymers with the potential for dual activation, as well as methods of manufacture and uses thereof. These compounds allow low-surface energy polymers, such as polyolefins and other polymers, to be firstly functionalized via C—H, O—H, and N—H insertion, installing reactive species on the polymeric chains. Polymers functionalized with diazirine moieties may then react with other polymers, or self-react, upon a second activation. The described dual activation method will create a new generation of active functionalized polymers which may covalently adhere to other polymers. Such a dual X—H insertion process is useful, for example, for forming topical coatings on low surface energy films which may then be painted with a second substrate, for covalent adhesive bonding, for creating rigid 3-dimensional polymeric structures by in-situ doping and activation of the crosslinker, or for functionalization of hydrogels and elastomers. The disclosed crosslinkers may be activated photochemically (visible light and UV radiation) and/or thermally.

Aspects disclosed herein comprise multi-diazirine-containing molecules and multi-diazirine-containing polymers (“polymeric diazirines”) with a dual activation functionality for use in the functionalization, crosslinking, and adhesion of polymeric materials. In particular, aspects disclosed herein may allow for the direct functionalization of any polymers containing C—H, O—H, N—H, and/or S—H bonds (elastomers, hydrogels, fibers, etc.): soft materials polymeric (polyurethane, silicone, nylon, poly(methylmethacrylate), aromatic polyamides (aramids), etc.) and the like; hard polymeric materials (epoxy resins, wood, paper, brick, concrete, glass, composite materials, etc.) and the like; and more challenging polymers such as low-surface energy materials (polyethylene, polyethylene terephthalate, polypropylene, and the like). Other low-surface energy plastics that lack aliphatic C—H, O—H, and/or N—H bonds may also be functionalized (fluoropolymers, polyketones, carbon fiber, and the like). Metals and ceramics may also be included.

Incorporating two (or more) diazirines with specifically tuned electronics (at least one type 1 and one type 2 diazirine per molecule, e.g. as defined below) on either end of a tether (or covalently bonded to a polymeric compound) may enable production of the desired carbene in a controlled manner.

Aspects disclosed herein may allow for functionalization of commercial polymers, such as polyolefins, generating new materials having reactive species that may be able to bond with other polymers, catalysts, or biologically relevant molecules.

Firstly, one (or more than one in the case of polymeric versions) electron-rich diazirine (type 1) may be activated using visible light (ca. 400 nm) or mild temperatures (60-80° C.), resulting in the covalent attachment of the molecule to a polymeric substrate. As a result of this transformation, a functionalized polymer may be generated with a tether bearing the second diazirine (electron-poor or electron-neutral; type 2). Subsequently, the type 2 diazirine may be activated using UV light (ca. 365 nm) or higher temperatures (above 100-110° C.). An example illustration of functionalization of polyolefins using selective activation of a bivalent crosslinker under mild conditions is shown in FIG. 1 (example of polymer functionalization).

The disclosure describes a compound of Formula I or Formula II:

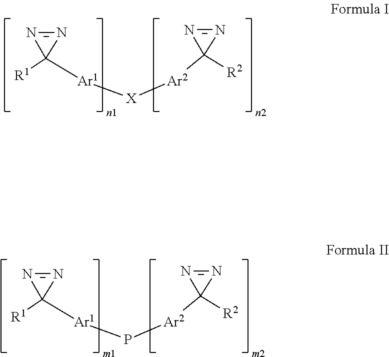

wherein Formula I and Formula II:
Ar¹ comprises any aromatic moiety with electron-donating substituents, or any aryl or heteroaryl moiety that is electron-rich relative to benzene;
Ar² comprises any aromatic moiety with electron-withdrawing or electron-neutral substituents (including alkyl groups), or any aryl or heteroaryl moiety that is electron-poor relative to benzene;
R¹ and R² are independently selected from among H, alkyl (including perfluoroalkyl), cycloalkyl, halogen, or ester groups.

And wherein within Formula I:
X comprises any linear or branched divalent, trivalent, or tetravalent linkers selected from the group consisting of saturated aliphatic chains, saturated ethers having from 2 to 20 carbon atoms, or optionally substituted heteroalkyl, alkenyl, alkynyl, cycloalkyl, heterocycloalkyl, aryl, arylalkyl, heteroaryl, and heteroarylalkyl. X may include chemically or enzymatically cleavable motifs within the chain, such as esters, silyl ethers, peptides, and the like.
   n¹ and n² are independently selected from integers ranging from 1 to 3.
And wherein within Formula II:
P comprises any oligomeric, or dendrimeric, or polymeric compound containing at least 3 repeat units, in which the aryl (or heteroaryl) diazirine moiety is grafted onto a suitable prepolymer or copolymer containing reactive residues, or the aryl (or heteroaryl) diazirine is included within the sidechain of a polymer or copolymer, or the aryl (or heteroaryl) diazirine included within the backbone of a polymer or copolymer.
   m¹ and m² are an independently selected from integers ranging from 1 to 1000.

### DESCRIPTION OF THE DRAWINGS

Reference is now made to the accompanying drawings, in which:

FIG. 1 is an example illustration of polymer functionalization;

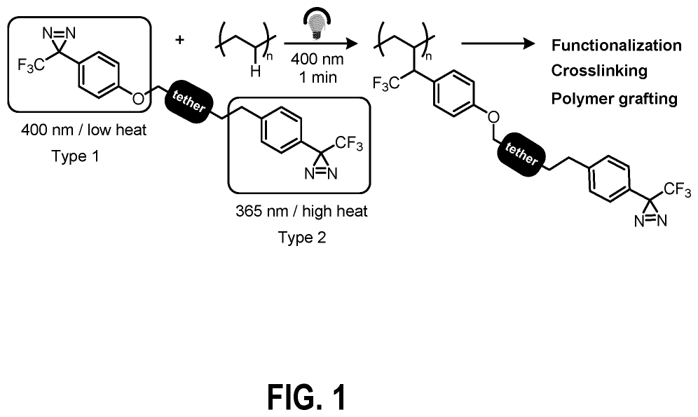

FIG. 2A is a ¹H NMR spectrum of a compound described by Formula III, indicating the successful synthesis of the dual-function crosslinker described in Example 1, in accordance with an embodiment;

FIG. 2B is a ¹⁹F NMR spectrum of a compound described by Formula III, indicating the desired presence of two electronically distinct trifluoromethyl diazirine motifs, in accordance with an embodiment;

FIG. 3 is a ¹H NMR spectrum of a compound described by Formula XII, indicating the successful synthesis of the dual-function polymeric diazirine described in Example 2, in accordance with an embodiment;

FIG. 4 is a ¹⁹F NMR spectrum indicating selective reaction of one diazirine group of a dual-function crosslinker of Formula III with polyethylene glycol, resulting in the functionalization of the target polymer as described in Example 4, in accordance with an embodiment; and

FIG. 5 is a schematic of dual activation of a polymeric diazirine, in accordance with an embodiment.

### DETAILED DESCRIPTION

The disclosure provides a compound of Formula I or Formula II:

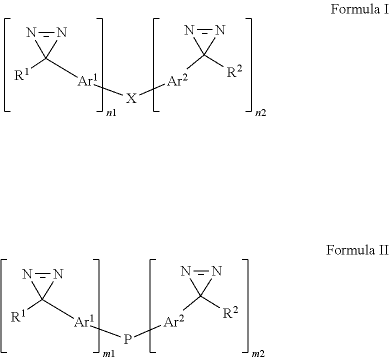

wherein in Formula I and Formula II:
Ar¹ comprises any aryl moiety with electron-donating substituents (para-OR, ortho-OR, para-OH, ortho-OH, para-NH, ortho-NH, para-NR, ortho-NR, para-SR, ortho-SR, para-SH, ortho-SH, and the like; wherein R is independently selected at each occurrence from hydrogen, optionally substituted: alkyl, heteroalkyl, alkenyl, alkynyl, cycloalkyl, heterocycloalkyl, aryl, arylalkyl, heteroaryl, and heteroarylalkyl). Ar¹ further comprises any aryl or heteroaryl moiety that is electron-rich relative to benzene.
Ar² comprises any aryl moiety with electron-withdrawing (para-perfluoroalkyl, para-halogens, para-carbonyl, para-esters, para-aldehydes, para-nitro, meta-OR, meta-OH, and the like; wherein R is independently selected at each occurrence from hydrogen, optionally substituted: alkyl, heteroalkyl, alkenyl, alkynyl, cycloalkyl, heterocycloalkyl, aryl, arylalkyl, heteroaryl, and heteroarylalkyl) or electron-neutral substituents (alkyl groups). Ar² further comprises any aryl or heteroaryl moiety that is electron-poor relative to benzene.
R¹ and R² are independently selected from among H, alkyl (including perfluoroalkyl), cycloalkyl, halogen, or ester groups.

The term alkyl, as used herein, refers to alkyl groups having from 1 to 50 carbons, and includes both linear and branched groups. Non-limiting example of such groups includes methyl, ethyl, and isopropyl. Such alkyl groups may be halogenated. Non-limiting examples of halogenated alkyl groups include fluoromethyl, difluoromethyl and trifluoromethyl. In exemplary embodiments, R¹ and R² are a CF₃ group.

The term cycloalkyl, as used herein, refers to cycloalkyl groups having from 1 to 6 carbons, and includes cyclopropyl, cyclobutyl, cyclopentyl, cyclohexyl and the like. Such cycloalkyl groups may be halogenated. Non-limiting examples of such groups include cyclopropyl and perfluoro-cyclopropyl.

As used herein, the term aryl (or aromatic) encompasses monocyclic and polycyclic aromatic groups such as phenyl, biphenyl, naphthyl, anthracenyl, pyrenyl and the like. It also encompasses heteroaromatic groups such as pyridyl, pyrimidinyl, pyrazinyl, quinolinyl, pteridinyl and the like.

Such aryl groups may be optionally substituted with selected fragments from the group consisting of alkyl, cycloalkyl, halo, hydroxy, alkoxy, amino, alcohols, ethers, carboxylic acids, esters, aldehydes, oximes, hydrazones, amides, thiol, thioethers, sulfinic acids, sulfonic acids, sulfon-amides, sulfonyl chlorides, boronic acids, boronic esters, and tetraalkylammonium substituents.

As used herein, the term alkylene refers to divalent, trivalent, or tetravalent alkylene groups having from 1 to 12 carbons, and includes both linear and branched alkylene groups, which may be halogenated.

As used herein, the term cycloalkylene refers to divalent, trivalent, or tetravalent cycloalkylene groups having from 1 to 12 carbons, which may be halogenated.
and wherein within Formula I:
X comprises any linear or branched divalent, trivalent, or tetravalent linkers selected from the group consisting of saturated aliphatic chains, saturated ethers having from 2 to 20 carbon atoms, or optionally substituted heteroalkyl, alkenyl, alkynyl, cycloalkyl, heterocycloalkyl, aryl, arylalkyl, heteroaryl, and heteroarylalkyl. X may include chemically or enzymatically cleavable motifs within the chain, such as esters, silyl ethers, peptides, and the like.
   n¹ and n² are independently selected from integers ranging from 1 to 3.
and wherein within Formula II:
P comprises any oligomeric, dendrimeric, or polymeric compound containing at least 3 repeat units, in which the aryl (or heteroaryl) diazirine moiety is grafted onto a suitable prepolymer or copolymer containing reactive residues, or the aryl (or heteroaryl) diazirine is included within the sidechain of a polymer or copolymer, or the aryl (or heteroaryl) diazirine included within the backbone of a polymer or copolymer.
   m¹ and m² are independently selected from integers ranging from 1 to 1000.

An embodiment (of a compound) of Formula I is one in which R¹ and R² are CF₃, Ar¹ is an aryl group with para-oxygen (para-O—) functionality, Ar² is an aryl group with a para-alkyl linkage (para-CH₂), and X is an heteroalkyl chain connected through an oxygen atom (Ar¹—CH₂CH₂O—Ar²), as in Formula III.

A second embodiment (of a compound) of Formula I is one in which R¹ and R² are CF₃, Ar¹ is an aryl group with para-oxygen (para-O—) functionality, Ar² is an aryl group with a para-alkyl linkage (para-CH₂), and X is an heteroalkyl chain connected through a nitrogen atom (Ar¹—CH₂CH₂NH—Ar²), as in Formula III.

A third embodiment (of a compound) of Formula I is one in which R¹ and R² are CF₃, Ar¹ is an aryl group with para-oxygen (para-O—) functionality, Ar² is an aryl group with a para-alkyl linkage (para-CH₂), and X is an heteroalkyl chain such as —CH₂—CH₂—Z— with Z corresponding to a heteroatom (O, NR, or S), R═H, Et, iPr, as in Formula III.

A fourth embodiment (of a compound) of Formula I is one in which R¹ and R² are CF₃, Ar¹ is an aryl group with a para-OCH₂CH₂ linkage, Ar² is an aryl group with a para-alkyl linkage (para-CH₂), and X is a heteroalkylaryl chain such as —Z—CH₂—C₆H₄—CH₂—Z— with Z corresponding to a heteroatom (O, NR, or S), R═H, Et, iPr, as in Formula IV.

Compounds with Formula III and Formula IV may be particularly advantageous:

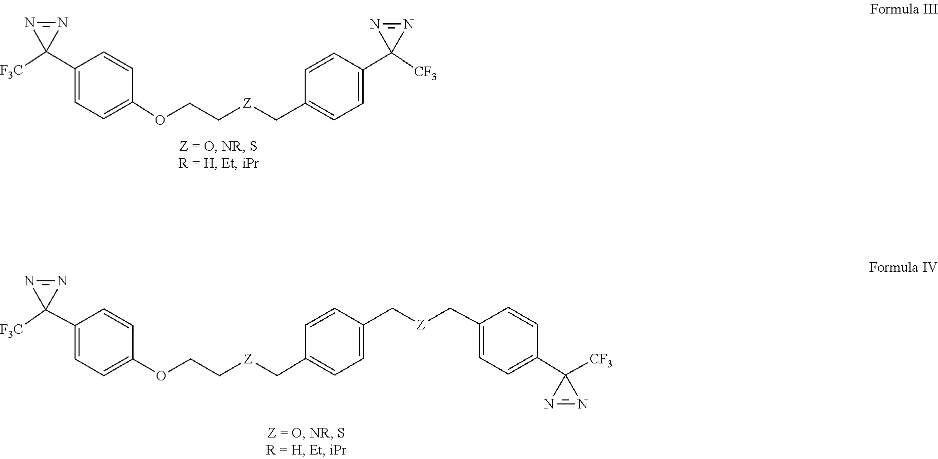

A fifth embodiment (of a compound) of Formula I is one in which R¹ and R² are CF₃, Ar¹ is an aryl group with a para-OCH₂CH₂ linkage, Ar² is an aryl group with a para-alkyl linkage (para-CH₂), and X is a —OC(O)Z— group, with Z corresponding to a heteroatom (O, NR, or S), R═H, Et, iPr, as in Formula V.

A sixth embodiment (of a compound) of Formula I is one in which R¹ and R² are CF₃, Ar¹ is an aryl group with a para-OCH₂CH₂ linkage, Ar² is an aryl group with a para-alkyl linkage (para-CH₂), and X is a —OS(R)₂Z— group, where R is either —CH₃, —CH₂CH₃, or —CH(CH₃)₂ and Z is an heteroatom (O, NR, or S), R═H, Et, iPr as in Formula VI.

Compounds with Formula V and Formula VI may be particularly advantageous:

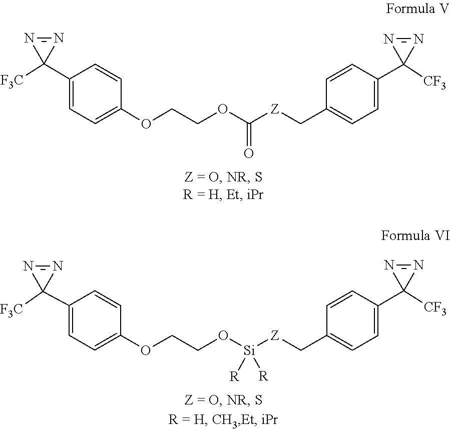

A seventh embodiment (of a compound) of Formula I is one in which R¹ and R² are CF₃, Ar¹ is an aryl group with a para-OCH₂CH₂ linkage, Ar² is an aryl group with a para-ester linkage (para-COO—), and X is a heteroalkyl chain such as a —Z-L-Z— group, wherein L is a group containing alkyl or heteroalkyl chains and Z is a heteroatom (O, N, S), as in Formula VII.

Compounds with Formula VII may be particularly advantageous:

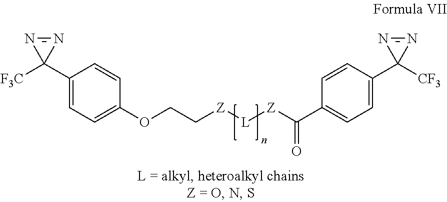

An eighth embodiment (of a compound) of Formula I is one in which R¹ and R² are CF₃, Ar¹ is an aryl group with a para-OCH₂CH₂ linkage, Ar² is an aryl group with a para-[CF₂]ₙ linkage, where n is an integer from 1 to 8, and Z is a heteroatom (O, N, S), as in Formula VIII.

Compounds with Formula VIII may be particularly advantageous:

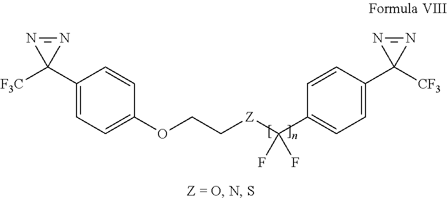

A ninth embodiment (of a compound) of Formula I is one in which R¹ and R² are CF₃, Ar¹ is an aryl group with a para-OCH₂CH₂ linkage, Ar² is an aryl group with a para-alkyl linkage (para-CH₂), where n¹ is 2 and n² is 1, and X is 2,4-O-6-Z-1,3,5-triazine, where Z is a heteroatom (O, N, S), as in Formula IX.

A tenth embodiment (of a compound) of Formula I is one in which R¹ and R² are CF₃, Ar¹ is an aryl group with a para-OCH₂CH₂ linkage, Ar² is an aryl group with a para-CH₂NH linkage, where n¹ is 2 and n² is 1, and

X is:

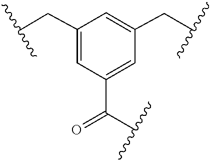 [SMILES: *Cc1cc(C*)cc(C(*)=O)c1]

as in Formula X.

An eleventh embodiment (of a compound) of Formula I is one in which R¹ and R² are CF₃, Ar¹ is an aryl group with a para-OCH₂CH₂ linkage, Ar² is an aryl group with a para-CH₂NH linkage, where n¹ is 1 and n² is 2, and

X is:

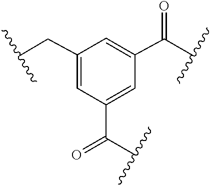 [SMILES: *Cc1cc(C(*)=O)cc(C(*)=O)c1]

as in Formula XI.

Compounds with Formula IX, X, and XI may be particularly advantageous:

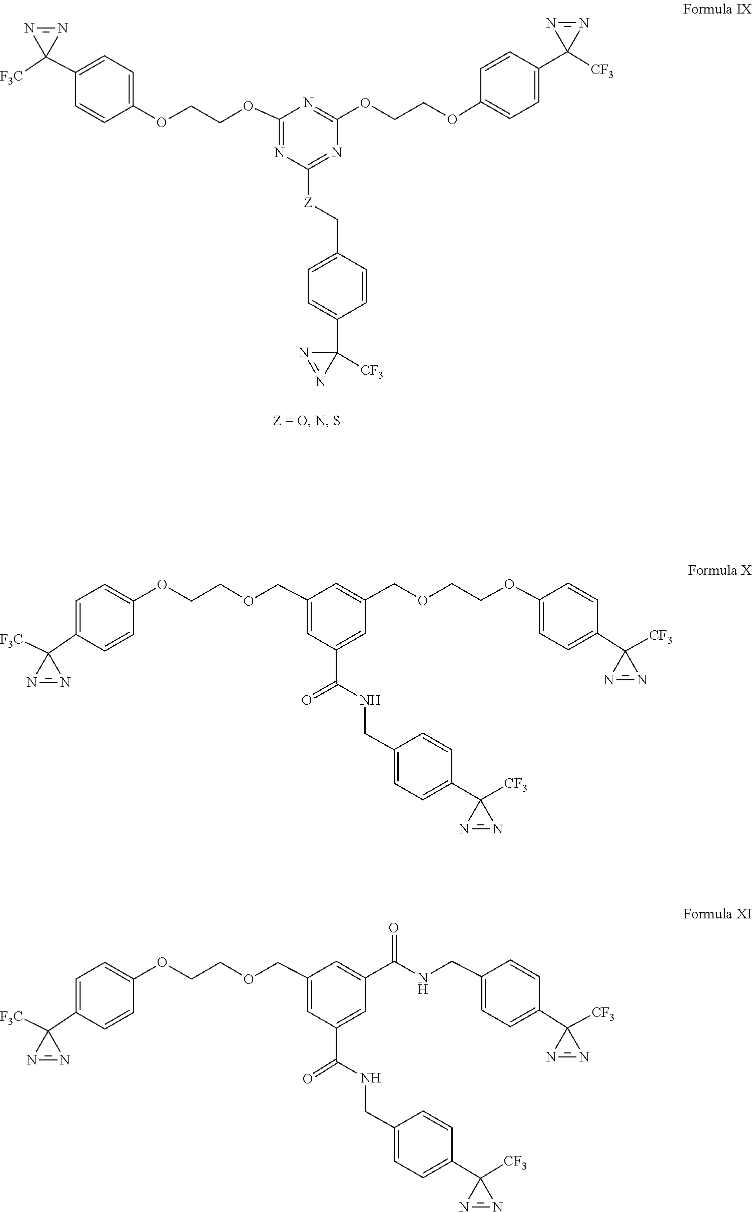

A embodiment (of a compound) of Formula II is one in which R¹ and R² are CF₃, Ar¹ is an aryl group with a para-OCH₂CH₂ linkage, Ar² is an aryl group with a para-CH₂ linkage, and P is a polyethylene amine, as in Formula XII.

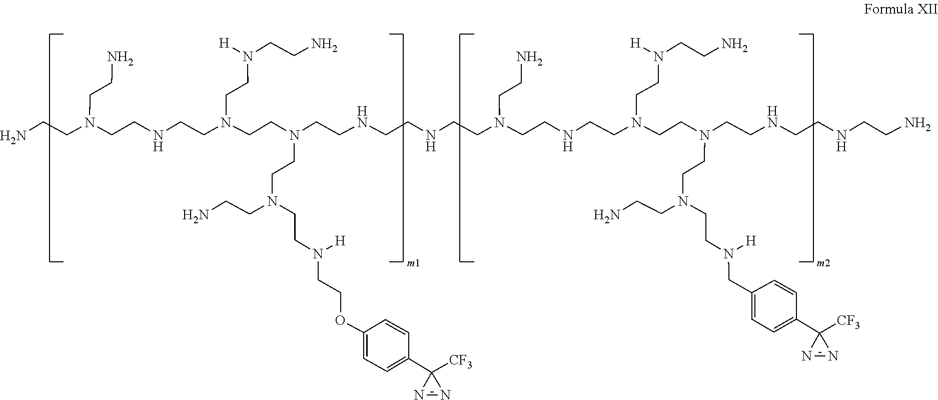

Compounds of Formula I and Formula II may be prepared using methods known in the art, as described herein. For example, they may be prepared by oxidation of a diaziridine precursor, which may in turn be obtained from the corresponding ketone or other suitable starting reagents. Examples 1-3 illustrate synthetic routes to prepare compounds of Formula I and Formula II.

### Example 1: Synthesis of a Representative Dual Diazirine-Based Molecule

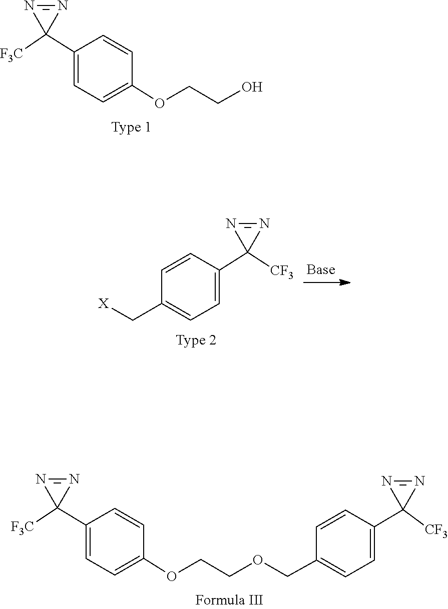

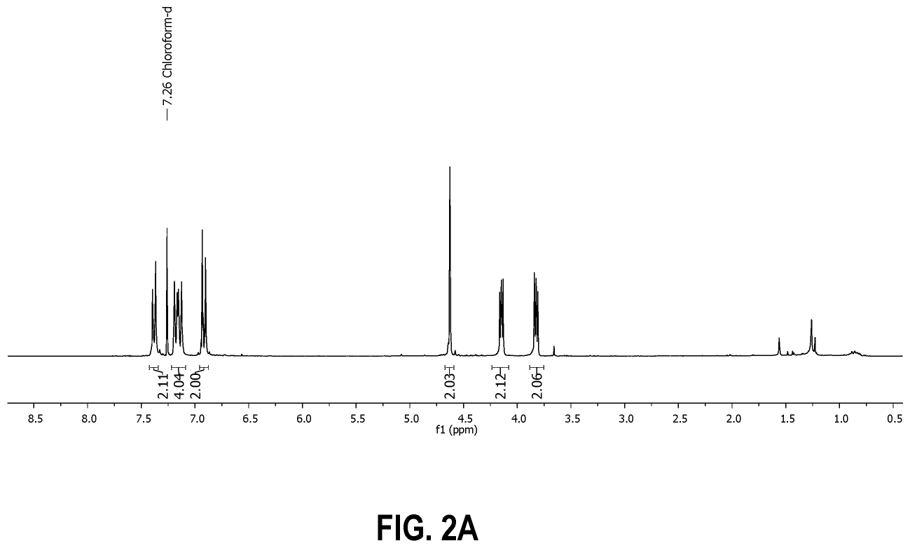

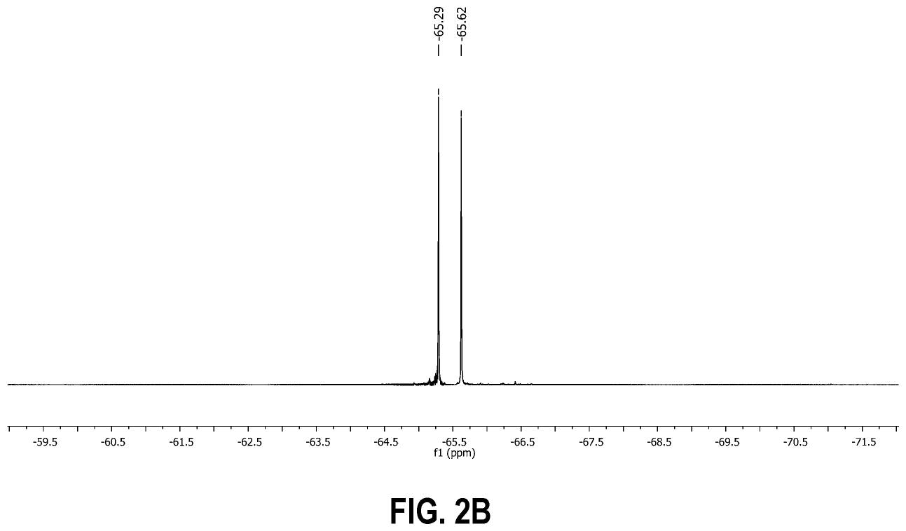

It is generally understood that the person skilled in the art would reasonably prepare compounds of Formula III. For example, a mixture 1:1 of type 1 and type 2 diazirine in appropriate solvent and base affords Formula III in quantitative yields as a yellow liquid. Suitable solvents include tetrahydrofuran, or diethyl ether in the presence of a suitable base or an alkaline metal and the like, where X is a halogen (chlorine, bromine or iodine) or a leaving group such as mesylate, tosylate, acetate and the like. ¹H NMR (300 MHz, CDCl₃) δ 7.38 (d, J=8.1 Hz, 2H), 7.23-7.03 (m, 4H), 6.92 (d, J=8.0 Hz, 2H), 4.63 (s, 2H), 4.34-4.03 (m, 2H), 3.91-3.70 (m, 2H). ¹⁹F NMR (283 MHz, CDCl₃) δ −65.29, −65.62. See FIGS. 2A-2B.

### Example 2: Synthesis of a Representative Dual Diazirine Polymer

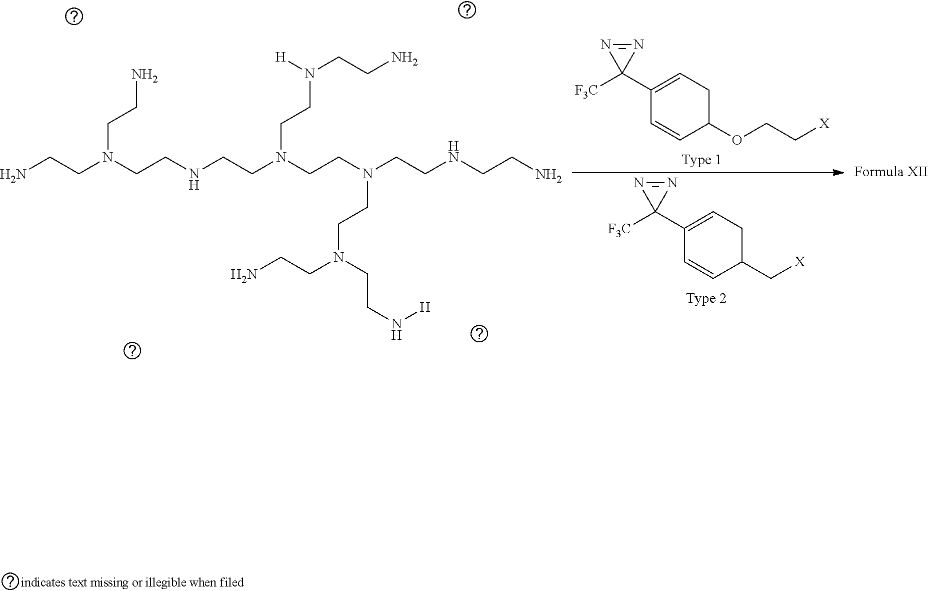

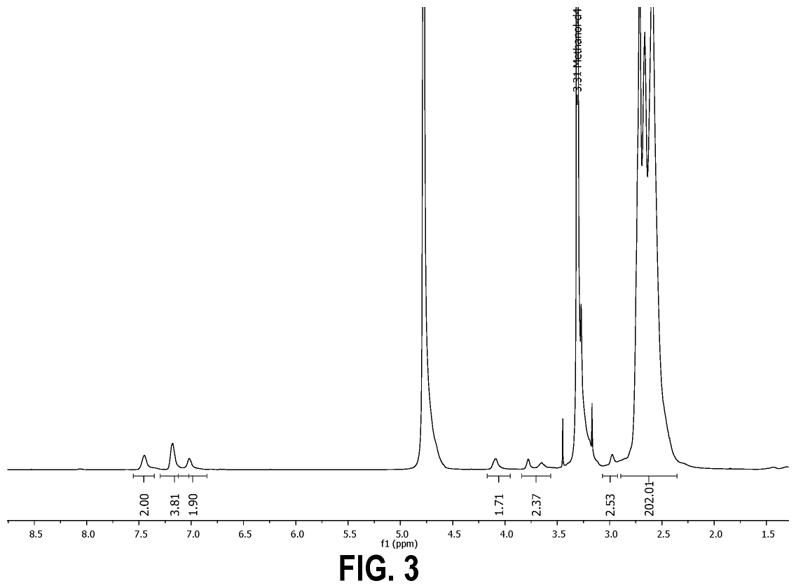

It is generally understood that the person skilled in the art would reasonably prepare compounds of Formula XII. For example, a mixture of type 1 (1-30 wt %) and type 2 (1-30 wt %) diazirine with polyethylenimine (Mw 25k) appropriate solvent affords Formula XI in quantitative yield as a pale-yellow viscous liquid. Suitable solvents include methanol, ethanol, or water and the like, where X is a halogen (chlorine, bromine or iodine) or a leaving group such as mesylate, tosylate, acetate and the like. ¹H NMR (500 MHz, MeOD) δ 7.45 (m, 2H), 7.18 (m, 4H), 7.02 (m, 2H), 4.09 (m, 2H), 3.71 (d, J=64.7 Hz, 2H), 2.93-2.21 (m, 200H). ¹⁹F NMR (283 MHz, MeOD) δ −66.76. See FIG. 3.

### Example 3: Synthesis of a Representative Dual Diazirine-Based Molecule

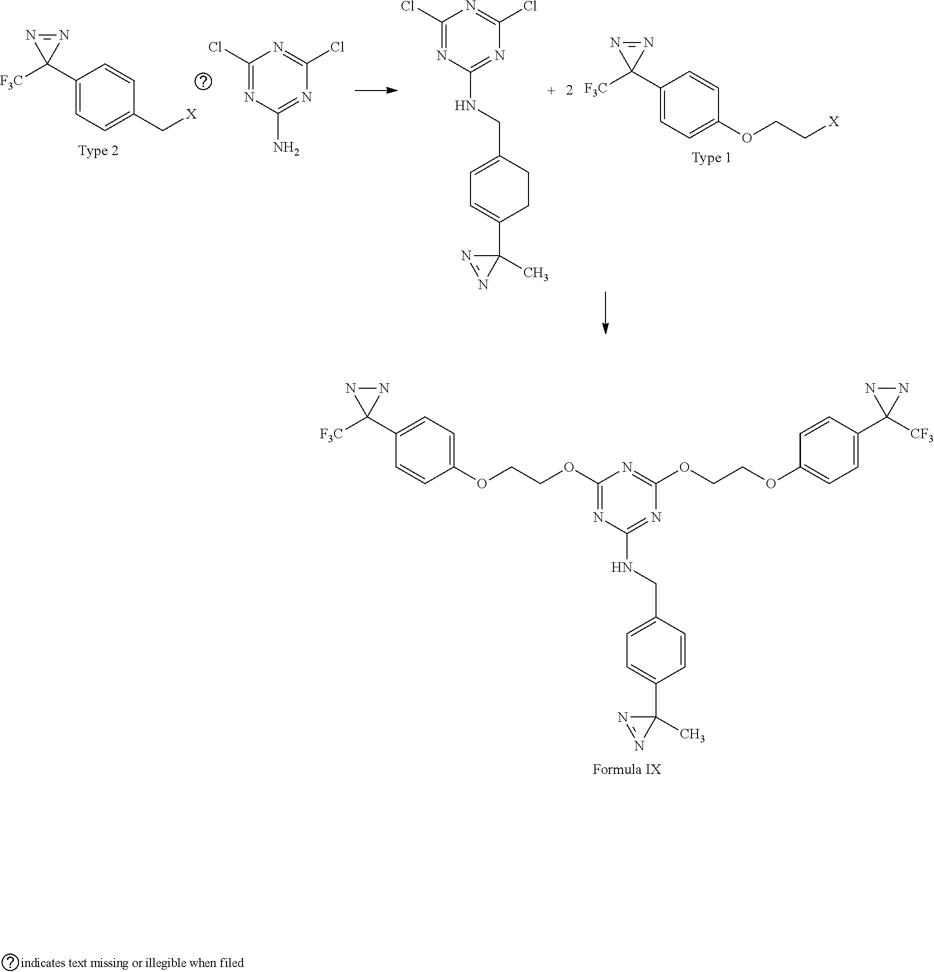

It is generally understood that compounds of Formula IX may be prepared in a variety of reasonable ways. For example, a mixture of type 2 diazirine, where X is a halogen (chlorine, bromine or iodine) or a leaving group such as mesylate, tosylate, acetate and the like, mixed with 4,6-dichloro-1,3,5-triazin-2-amine in an appropriate solvent may afford 4,6-dichloro-N-(4-(3-(trifluoromethyl)-3H-diazirin-3-yl)benzyl)-1,3,5-triazin-2-amine. The crude product is then reacted with 2 equivalents of Type 1 diazirine and a suitable base affording Formula IX. Suitable solvents include tetrahydrofuran or diethyl ether in the presence of a suitable base or an alkaline metal and the like.

Compounds of Formula I and Formula II may be useful as functionalizing molecules or polymers, and crosslinkers, and may have advantages over methods of the art.

They may have a selective dual mode of activation which consist of at least one diazirine activating at 395-405 nm and 60-90° C. and at least one diazirine activating at 350-365 nm and above 100° C. This allows for the controllable functionalization and crosslinking of essentially any polymer that contains C—H, O—H or N—H bonds.

Moreover, such crosslinkers may permit the generation of functionalized materials with active diazirine moieties which then may further crosslink other polymers or compounds.

The compounds of Formula I and Formula II may work by losing nitrogen to form reactive carbenes, which may then undergo C—H, O—H, or N—H insertion with polymers. This leads to chemical crosslinks. The crosslinking process may increase the material strength of the target polymer, increase the melting temperature, decrease solubility, etc. If two pieces of polymer have a layer of crosslinker applied between them, then the crosslinking process may result in adhesion.

Without intending to limit the scope of aspects disclosed herein, it is thought that upon the first activation (at 395-405 nm or at 60-90° C.) compounds of Formula I and Formula II may preferentially yield singlet carbenes upon loss of nitrogen, rather than triplet carbenes. Because subsequent C—H insertion steps may be nearly barrierless, they may allow chemical crosslinking to proceed without β-scission or other fragmentation reactions taking place.

Moreover, the crosslinking process may take place with completely unfunctionalized polymers (e.g. polyethylene, polypropylene) as well as other important polymers that contain functionality but may still not be disposed toward crosslinking (e.g. polylactic acid, polycaprolactone). Compounds of Formula I and Formula II also have advantages for polymers which may be crosslinked by more traditional methods (e.g. silicones), but for which there exist limitations with the current crosslinking technologies. Compounds of Formula I and Formula II may be activated thermally, photochemically, electrically, or using transition metals.

In principle, compounds of Formula I and Formula II may be used to functionalize any organic polymer which has C—H or O—H or N—H bonds. Proof-of-concept experiments with polyethylene glycol in Example 4 bear this out. Embodiments can include combinations of the above features.

### Example 4: Functionalization of Polyethylene Glycol

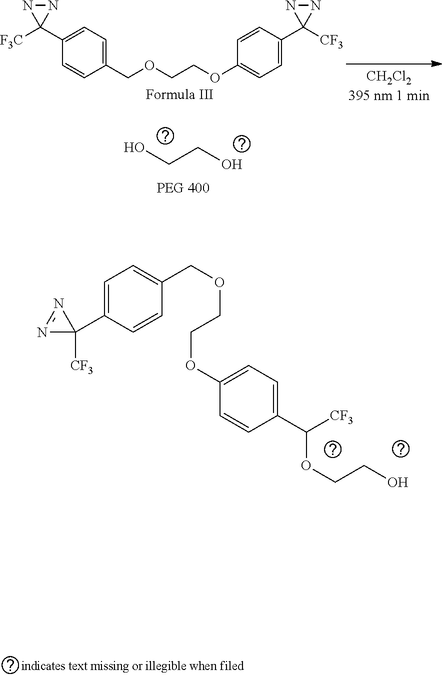

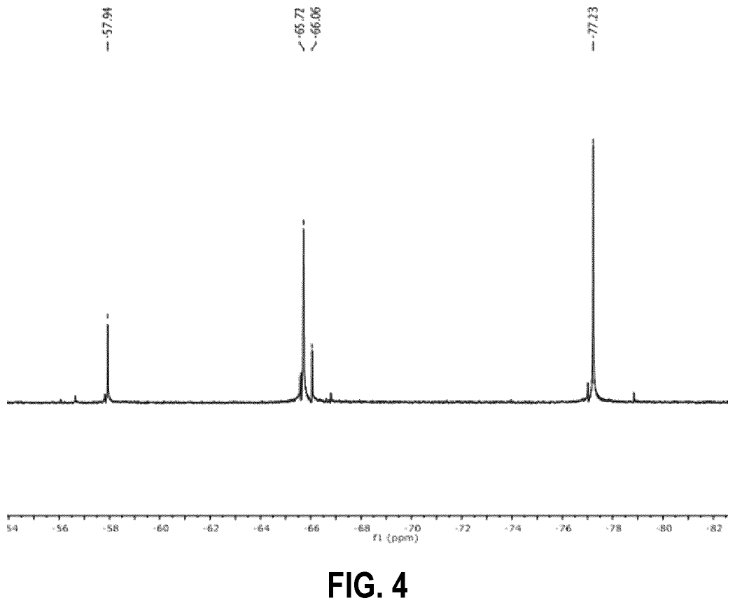

It is generally understood that the functionalization of PEG 400, or any other polymers, may be enabled using a selective activation of type 1 diazirine, as described in the scheme of example 4. A mixture of Formula III and PEG 400 in dichloromethane is irradiated with 395 nm light for 1 minute. The product of the reaction is a functionalized PEG 400 with a tether covalently linked to it bearing a diazirine of type 2. The type 2 diazirine may then be activated upon irradiation using a 365 nm light or thermally using above 100° C. temperatures. See FIG. 4.

In many applications, it is important to improve the polymeric surface without modifying the bulk proprieties of the materials. Thus, the chemical structure of various polymeric materials may be functionalized by the topical application or in-situ addition, and activation, of the crosslinkers, described herein.

Topical application of the bivalent crosslinkers described herein may increase the polymer's surface energy, which may be a key parameter that expands the commercial uses of such materials. Higher surface energy may increase adhesion strength. Selected polymer substrates include low surface energy materials with C—H bonds, for example, polyethylene and polypropylene. Materials with O—H or N—H bonds may also applicable.

The format of such polymeric materials includes, for example, premade objects, films, powders, sheets, bare fibres, mesh and ribbons. Such format materials may be further processed into shapes such as braided lines or ropes, woven and non-woven fabric, alternating orthogonal layers of unidirectional fibres, knitted fabric, laminated films and mesh or web constructs.

Powdered polymeric materials may also be sintered or pressure compacted into various shapes. For materials comprised of woven or non-woven fibres, braided lines or ropes, it may be advantageous to use a vacuum or high pressure to facilitate higher penetration of the crosslinker molecule and solvent carrier into such processed material.

The bivalent crosslinkers described herein may also be incorporated into the polymer material itself by, for example, by pressure or solvent infusion, where such infusion substantially disperses the crosslinker within the polymer. Such infusion may be accomplished by dissolving the crosslinker in, for example, a volatile organic solvent such as pentane, (which may be removed prior to activation) at a temperature that does not melt the polymer or cause the bivalent crosslinker to activate.

Optionally, a vacuum may be first applied to achieve higher crosslinker penetration in materials constructed of braided, woven and non-woven fibres, bare fibres, or strands of fibres. Alternatively, the crosslinker may be pressure infused with or without the use of a solvent carrier.

The addition of a crosslinker may also be accomplished by adding the crosslinker directly into the polymer melt or extruder.

Various applications of the crosslinkers disclosed herein are described below.

### Generic Application of Dual Selective Bivalent Crosslinkers

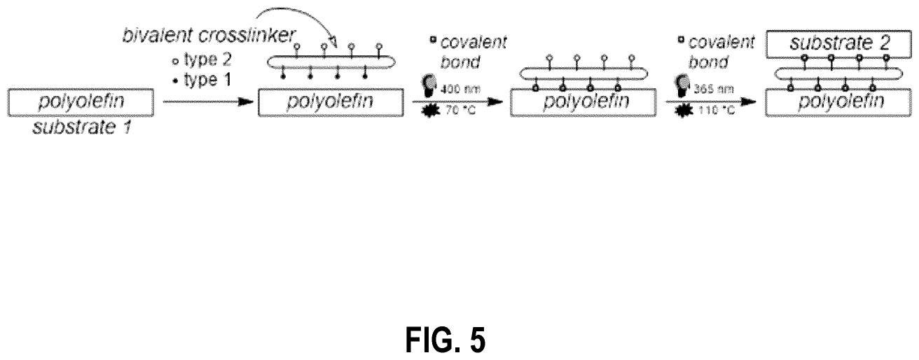

Aspects disclosed herein relate to a series of bivalent crosslinkers (small-molecule- or polymer-based) which present a mixture of type 1 and type 2 diazirine species, as shown in FIG. 5. The different properties of type 1 and type 2 diazirines allow the activation of bivalent crosslinkers in a selective manner. When the bivalent crosslinker is exposed to 390-405 nm light or low temperatures (60-90° C.), the type 1 diazirine is activated, forming a reactive species which undergoes insertion on the adjacent substrate 1 (e.g. polyolefin) whereas type 2 diazirines remain unreacted. Functionalization of substrate 1 allows further adherence or further functionalization of the material with any other polymer or material, hydrogels, or small molecules (e.g. dyes). See FIG. 5.

The following applications illustrate some of the chemical modifications made possible by the addition of the disclosed bivalent crosslinkers. It is understood that other applications not described herein may be possible.

### Application 1—Functionalization of Polyolefins and Adhesion

The topical treatment of such low surface energy polymers using at least one of the crosslinkers disclosed herein may provide a new and convenient method to functionalize low surface energy materials, and then bond them together or to other low surface energy materials. Such topical treatment may change the polymer surface functionality in a controlled manner, thereby enabling the surface bonding of moieties such as dyes or metallic vapour-deposited films, including, for example, acrylic and cyanoacrylate-based adhesives.

The crosslinkers disclosed herein may be conveniently applied on selected films and then photochemically or thermally activated to create a strong covalent bond. Then, a second substrate may adhere to the substrate (e.g. silicone, fluoropolymers, fluorescent molecules, elastomers, etc.).

Application 2—Infusion of Crosslinkers into Polyolefin Films

Polyolefin films are used globally for packaging, including food packaging. Tensile strength, low surface energy, tear strength, gas diffusion, and UV degradation are some of the key parameters which limit the use of these films. Such parameters may be modified by incorporating at least one of the crosslinkers disclosed herein into the material itself. The incorporation of the crosslinker into the polymer material itself may be achieved by, for example, pressure or solvent infusion, where such infusion substantially disperses the crosslinker within the polymer. Such infusion may be accomplished by dissolving the crosslinker in, for example, a volatile organic solvent such as pentane, (which may be removed prior to activation) at a temperature that does not melt the polymer or cause the bivalent crosslinker to activate.

### Application 3—Functionalization of Hydrogels and Elastomers

The bivalent crosslinkers disclosed herein may be used for the functionalization of hydrogels (e.g. alginates, gelatine) or elastomers (e.g. silicone, polyurethane, etc.). Following insertion of type 1 diazirine, hydrogels/elastomers may be functionalized or crosslinked, upon activation of type 2 diazirine. Dynamic crosslinking may be achieved using Formula V or VI, or Formula IX, and the like.

### Application 4—Preparation of Composite Materials

The bivalent crosslinkers disclosed herein, in particular compounds of Formula II, may be used to functionalize UHMWPE woven or non-woven fabrics and related materials. The fabric sheets may be treated with Formula II crosslinkers and functionalized upon activation of type 1 diazirines. Multiple layers of functionalized fabric sheets, with a reinforcement material in between, may then be used to form composite materials.

Application 5—Direct Addition of Crosslinkers into the Polymer Melt or Extrudant

The addition of one or more of the bivalent crosslinkers disclosed herein to a polymer melt or extrudant, followed by initiation of functionalization by thermal, photochemical, or other means either during the extrusion process or following extrusion, may be used to control the material properties of the final polymer object.

Application 6—Pressure or Solvent Infusion of Bivalent Crosslinkers into UHMWPE for Medical Implants

Shaped UHMWPE constructs are currently used as prostheses in medical implants. Such prior art implants have been modified using gamma-irradiation to increase material tensile strength. Such treatment using radiation is expensive, and thus limits widespread use. Pressure or solvent infusion of at least one of the crosslinkers described herein, followed by visible light activation, provides a convenient, cost-effective method to modify such UHMWPE prostheses.

Application 7—Pressure or Solvent Infusion of Bivalent Crosslinkers into UHMWPE Woven or Non-Woven Fabrics and Related Materials-Fabric Enhancer

Such UHMWPE constructs, comprised of fibres braided into lines or ropes, and woven, non-woven or knitted articles, have several potential commercial applications. For example, 100 gsm (gram per square metre) plain woven UHMWPE fabric, which has utility for ballistic protective garments, may be modified by the pressure or solvent infusion of at least one of the crosslinkers described herein which, when activated, may enhance the properties of the fabrics. Functionalized fabrics may be used for further adhesion of secondary substrates.

### Application 8—3D-Printing

The 3D-printing of a wide array of articles using various thermoplastic polymers has expanded rapidly, with diverse applications of this elegant technology. However, the physical properties of such printed polymer articles may be limited by the inherent properties of the polymers used during printing. The opportunity to modify the physical properties of a printed polymer article by thermal activation, UV activation, or activation through the use of an applied electric field, using at least one of the bivalent crosslinkers disclosed herein, provides the user with heretofore new commercial possibilities.

### Application 9—Adhesion of Biomolecules or Catalysts to Commodity Polymers.

Biomolecules or catalysts could likewise be easily attached to commodity polymers for potential flow chemistry or biological screening applications.

What is claimed is:

1. A compound having a Formula I or Formula II, in which 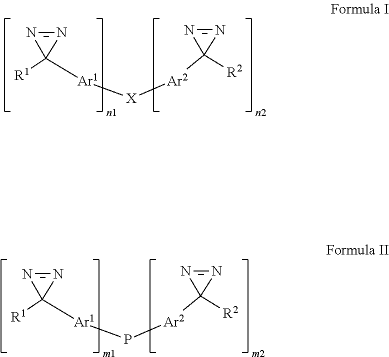
and wherein
Ar¹ comprises any aromatic moiety with electron-donating substituents, or any aryl or heteroaryl moiety that is electron-rich relative to benzene;
Ar² comprises any aromatic moiety with electron-withdrawing or electron-neutral substituents (including alkyl groups), or any aryl or heteroaryl moiety that is electron-poor relative to benzene;
R¹ and R² are independently selected from among H, alkyl (including perfluoroalkyl), cycloalkyl, halogen, or ester groups;
X comprises any linear or branched divalent, trivalent, or tetravalent linkers selected from the group consisting of saturated aliphatic chains, saturated ethers having from 2 to 20 carbon atoms, or optionally substituted heteroalkyl, alkenyl, alkynyl, cycloalkyl, heterocycloalkyl, aryl, arylalkyl, heteroaryl, and heteroarylalkyl. X may include chemically or enzymatically cleavable motifs within the chain, such as esters, silyl ethers, peptides, and the like;
n¹ and n² are independently selected from integers ranging from 1 to 3;
P comprises any oligomeric, or dendrimeric, or polymeric compound containing at least 3 repeat units, in which the aryl (or heteroaryl) diazirine moiety is grafted onto a suitable prepolymer or copolymer containing reactive residues, or the aryl (or heteroaryl) diazirine is included within the sidechain of a polymer or copolymer, or the aryl (or heteroaryl) diazirine included within the backbone of a polymer or copolymer; and
m¹ and m² are independently selected from integers ranging from 1 to 1000.

2. The compound of claim 1, wherein R¹ and R² are CF₃ groups.

3. The compound of claim 1, wherein Ar¹ is an electron-rich aromatic or heteroaromatic ring.

4. The compound of claim 1, wherein Ar² is an electron-neutral aromatic or heteroaromatic ring.

5. The compound of claim 1, wherein Ar² is an electron-poor aromatic or heteroaromatic ring.

6. The compound of any one of claims 1-4, wherein P comprises any oligomeric, dendrimeric, or polymeric compound containing at least 3 repeat units.

7. The compound of any one of claims 1-6, wherein P is a polyamine.

8. A method of functionalizing a polymer substrate using a compound of Formula I or Formula II according to any one of claims 1-7.

9. The method of claim 8, wherein the functionalizing step is accomplished photochemically using 380-450 nm light, or thermally at ≥60° C.

10. The method of any one of claims 8-9, wherein the second diazirine motif is activated photochemically using 340-375 nm light, or thermally at ≥100° C.

11. The method of claim 8, wherein one or both types of diazirine groups are activated with the aid of a photosensitizer.

12. The use of a diazirine-containing polymer of Formula II according to any one of claims 1-7 for the functionalization and adhesion of a substrate comprising a non-biological material.
